(19) United States
(12) Patent Application Publication
(10) Pub. No.: US 2017/0233004 A1
(43) Pub. Date: Aug. 17, 2017

(54) VEHICLE CONTROL DEVICE, VEHICLE CONTROL METHOD, AND VEHICLE CONTROL PROGRAM

(71) Applicant: Honda Motor Co., Ltd., Tokyo (JP)

(72) Inventor: Kunimichi Hatano, Wako-shi (JP)

(73) Assignee: Honda Motor Co., Ltd., Tokyo (JP)

(21) Appl. No.: 15/422,649

(22) Filed: Feb. 2, 2017

(30) Foreign Application Priority Data
Feb. 17, 2016 (JP) 2016-028206

(51) Int. Cl. B62D 15/02; B62D 6/00; G05D 1/02; B62D 1/04

(52) U.S. Cl. CPC B62D 15/025; B62D 1/04; B62D 6/002; B62D 15/0255; G05D 1/021; G05D 2201/0213; Y10S 903/902; G05D 1/0246; G05D 1/0255; G05D 1/0248; B60Y 2200/91; B60Y 2200/92; B60Y 2300/10; B60Y 2300/18166

(57) ABSTRACT

A vehicle control device according to an embodiment of the present disclosure includes a path generating unit and a control unit. The path generating unit generates a target path used by a vehicle to reach a destination. The control unit controls at least steering of the vehicle such that the vehicle travels along the target path generated by the path generating unit and increases a degree by which deviation from the target path is suppressed in a particular situation.

### CROSS REFERENCES TO RELATED APPLICATIONS

The present application claims priority under 35 U.S.C. §119 to Japanese Patent Application No. 2016-028206, filed Feb. 17, 2016, entitled “Vehicle Control Device, Vehicle Control Method, and Vehicle Control Program.” The contents of this application are incorporated herein by reference in their entirety.

### TECHNICAL FIELD

The present disclosure relates to a vehicle control device, a vehicle control method, and a vehicle control program.

### BACKGROUND

Research on techniques for controlling at least steering of a vehicle so that the vehicle travels along a target path generated on the basis of a route to a destination has been conducted recently. In relation to these techniques, a driving assistance device is known which includes an instruction unit for instructing starting of autonomous driving of a vehicle in response to an operation performed by a driver, a setting unit for setting a destination of the autonomous driving, a determination unit for determining an autonomous driving mode on the basis of whether the destination has been set when the instruction unit is operated by the driver, and a control unit for performing vehicle travel control based on the autonomous driving mode determined by the determination unit. When no destination has been set, the determination unit determines, as the autonomous driving mode, autonomous driving in which the vehicle is caused to travel along a current travel path thereof or autonomous stopping (see, for example, International Publication No. 2011/158347).

However, since control is uniformly performed for deviation from the target path in the techniques of the related art, the techniques of the related art fail to make the occupant of the vehicle feel safe in particular situations.

### SUMMARY

The present application describes, for example, a vehicle control device, a vehicle control method, and a vehicle control program that allow that an occupant of a vehicle to feel safe in particular situations.

According to a first aspect, there is provided a vehicle control device (100, 100A) including a path generating unit (110, 118) that generates a target path used by a vehicle to reach a destination; and a control unit (130, 134, 160) that controls at least steering of the vehicle such that the vehicle travels along the target path generated by the path generating unit and that increases a suppressing degree by which deviation from the target path is suppressed in a particular situation.

According to a second aspect, in the vehicle control device according to the first aspect, the particular situation may be a situation where the vehicle performs lane changing in accordance with the target path generated by the path generating unit.

According to a third aspect, in the vehicle control device according to the second aspect, the control unit may set the suppressing degree to be the largest at a timing at which a reference point of the vehicle crosses a lane marking during the lane changing.

According to a fourth aspect, the vehicle control device according to any one of the first to third aspects may further include a reaction force output unit (92E) that outputs an operation reaction force to an operation device (92A) that accepts a steering instruction from an occupant of the vehicle, wherein the control unit may control the operation reaction force output by the reaction force output unit such that the deviation from the target path is suppressed.

According to a fifth aspect, the vehicle control device according to any one of the first to fourth aspects may further include a steering force output unit (92F) that outputs a steering force, wherein the control unit may control the steering force output by the steering force output unit such that the deviation from the target path is suppressed.

According to a sixth aspect, in the vehicle control device according to the fifth aspect, the control unit may control the steering force output by the steering force output unit such that the deviation from the target path is suppressed by setting, if an operation performed on an operation device that accepts a steering operation from an occupant of the vehicle is in a direction for suppressing the deviation from the path, a steering force to be output by the steering force output unit in a direction corresponding to the operation to be larger than a steering force to be output by the steering force output unit in a direction corresponding to an operation that is performed on the operation device and that is in a direction for increasing the deviation from the target path.

According to a seventh aspect, there is provided a vehicle control method performed by a computer mounted in a vehicle, including generating a target path used by the vehicle to reach a destination; controlling at least steering of the vehicle such that the vehicle travels along the generated target path; and increasing a degree by which deviation from the target path is suppressed in a particular situation.

According to an eighth aspect, there is provided a vehicle control program causing a computer mounted in a vehicle to execute: a process of generating a target path used by the vehicle to reach a destination; a process of controlling at least steering of the vehicle such that the vehicle travels along the generated target path; and a process of increasing a degree by which deviation from the target path is suppressed in a particular situation.

In the above explanation of the exemplary aspects of embodiment, specific elements with their reference numerals are indicated by using brackets. These specific elements are presented as mere examples in order to facilitate understanding, and thus, should not be interpreted as any limitation to the accompanying claims. According to embodiments, for example, it is possible to allow an occupant of a vehicle to feel further safe in particular situations.

### BRIEF DESCRIPTION OF THE DRAWINGS

The advantages of the disclosure will become apparent in the following description taken in conjunction with the following drawings.

FIG. 1 is a diagram illustrating components of a vehicle in which a vehicle control device is mounted.

FIG. 2 is a functional configuration diagram of the vehicle in which a vehicle control device according to a first embodiment is mounted.

FIG. 3 is a diagram illustrating an example of the configuration of a steering unit.

FIG. 4 is a diagram illustrating how the relative position of the vehicle in a lane where the vehicle is traveling is recognized by a vehicle position recognizing unit.

FIG. 5 is a diagram illustrating an example of an action plan generated for a certain section.

FIGS. 6A to 6D are diagrams each illustrating an example of a path generated by a path generating unit.

FIG. 7 is a flowchart illustrating an example of the flow of a process performed when a lane changing event is performed.

FIG. 8 is a diagram illustrating how a target position range is set.

FIG. 9 is a diagram illustrating how a path for lane changing is generated.

FIG. 10 is a diagram for describing an example of an operation reaction force determination method.

FIG. 11 is a diagram for describing another example of an operation reaction force determination method.

FIG. 12 is a diagram illustrating how an operation reaction force is relatively increased with respect to a difference.

FIG. 13 is a diagram illustrating how the degree by which deviation from a path is suppressed changes before and after lane changing.

FIG. 14 is a diagram illustrating how an operation reaction force is determined on the basis of a steering angle (measured value).

FIG. 15 is a diagram illustrating an example of the configuration of a vehicle control device according to a second embodiment.

FIG. 16 is a diagram illustrating output characteristics of an assist motor according to the second embodiment.

FIG. 17 is a diagram illustrating how the output characteristics of the assist motor are relatively increased.

### DETAILED DESCRIPTION

A vehicle control device, a vehicle control method, and a vehicle control program according to embodiments of the present disclosure will be described below with reference to the accompanying drawings.

### First Embodiment

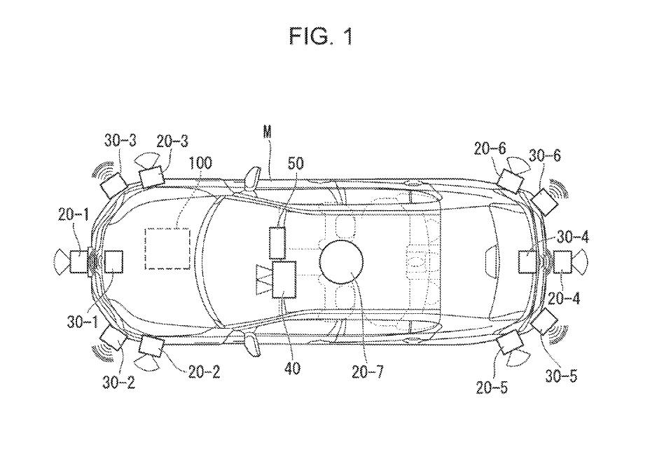

FIG. 1 is a diagram illustrating components of a vehicle (hereinafter, referred to as a “vehicle M”) in which a vehicle control device 100 is mounted. The vehicle in which the vehicle control device 100 is mounted is a vehicle with two, three, or four wheels, for example. Examples of such a vehicle include a vehicle that uses an internal combustion engine such as a diesel engine or a gasoline engine as its power source, an electric vehicle that uses a motor as its power source, a hybrid vehicle including both an internal combustion engine and a motor, and so forth. In addition, the aforementioned electric vehicle is driven by using electric power obtained by discharge of a battery cell, such as a secondary battery cell, a hydrogen fuel cell, a metal fuel cell, or an alcohol fuel cell, for example.

As illustrated in FIG. 1, the vehicle M includes sensors such as rangefinders 20-1 to 20-7, radars 30-1 to 30-6, and a camera 40; a navigation system 50; and the vehicle control device 100. Each of the rangefinders 20-1 to 20-7 is, for example, a LIDAR (Light Detection and Ranging or Laser Imaging Detection and Ranging) device that measures scattered light of emitted light to measure a distance to a target. For example, the rangefinder 20-1 is attached to the front grille or the like. Each of the rangefinders 20-2 and 20-3 is attached to a side of the body of the vehicle, a sideview mirror, inside of a headlamp, a portion near a side marker lamp, or the like. The rangefinder 20-4 is attached to a trunk lid or the like. Each of the rangefinders 20-5 and 20-6 is attached to a side of the body of the vehicle, inside of a rear position lamp, or the like. The aforementioned rangefinders 20-1 to 20-6 have a horizontal-direction detection range of about 150 degrees, for example. The rangefinder 20-7 is attached to the roof or the like. The rangefinder 20-7 has a horizontal-direction detection range of about 360 degrees, for example.

The aforementioned radars 30-1 and 30-4 are, for example, long-range millimeter wave radars having a wider depth-direction detection range than the other radars. In addition, the radars 30-2, 30-3, 30-5, and 30-6 are middle-range millimeter wave radars having a narrower depth-direction detection range than the radars 30-1 and 30-4. Hereinafter, the rangefinders 20-1 to 20-7 are simply referred to as “rangefinders 20” when they are not particularly distinguished from one another, and the radars 30-1 to 30-6 are simply referred to as “radars 30” when they are not particularly distinguished from one another. Each of the radars 30 detects an object by using FM-CW (Frequency Modulated Continuous Wave) method, for example.

The camera 40 is, for example, a digital camera that uses a solid-state imaging element, such as a CCD (Charge Coupled Device) or CMOS (Complementary Metal Oxide Semiconductor) imaging element. The camera 40 is attached to an upper portion of the front windshield, the back surface of the rearview mirror, or the like. The camera 40 periodically captures an image of a scene in front of the vehicle M, for example.

Note that the configuration illustrated in FIG. 1 is merely an example, and part of the configuration may be omitted or another configuration may be further added.

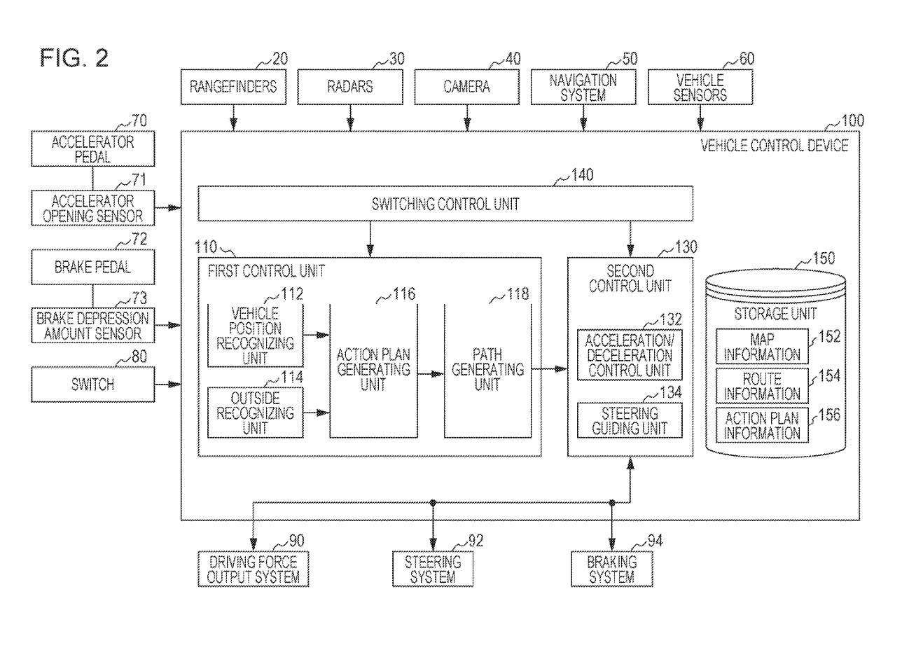

FIG. 2 is a functional configuration diagram of the vehicle M in which the vehicle control device 100 according to the first embodiment is mounted. In addition to the rangefinders 20, the radars 30, and the camera 40, the vehicle M includes the navigation system 50; vehicle sensors 60; operation devices such as an accelerator pedal 70 and a brake pedal 72 for instructing acceleration and deceleration; acceleration/deceleration operation detection sensors such as an accelerator opening sensor 71 and a brake depression amount sensor (brake switch) 73; a switch 80; a driving force output system 90, a steering unit 92; a braking system 94; and the vehicle control device 100. These systems and devices are connected to one another via a multiplex communication line such as a CAN (Controller Area Network) communication line, a serial communication line, a wireless communication network, or the like. Note that the aforementioned operation devices are merely an example, and the vehicle M may be equipped with a joystick, buttons, a dial switch, a lever, or a GUI (Graphical User Interface)-based switch.

The navigation system 50 includes a GNSS (Global Navigation Satellite System) receiver, map information (map for navigation), a touchscreen display device that functions as a user interface, a speaker, and a microphone. The navigation system 50 identifies the location of the vehicle M by using the GNSS receiver and determines a route from the identified location to the destination specified by the user. The route determined by the navigation system 50 is stored as route information 154 in a storage unit 150. The location of the vehicle M may be identified or compensated for by an INS (Inertial Navigation System) that uses the output of the vehicle sensors 60. The navigation system 50 provides the route to the destination by audio or displaying when the vehicle control device 100 is carrying out a manual driving mode. The configuration used to identify the location of the vehicle M may be provided independently from the navigation system 50. In addition, the navigation system 50 may be implemented as one of functions of a user's terminal device, such as a smartphone or tablet terminal, for example. In this case, the terminal device and the vehicle control device 100 exchange information via wired or wireless communication.

The vehicle sensors 60 include a vehicle speed sensor that detects the speed of the vehicle M, an acceleration sensor that detects acceleration, a yaw-rate sensor that detects an angular velocity around the vertical axis, and a direction sensor that detects the direction in which the vehicle M is heading, for example.

The operation detection sensors include the accelerator opening sensor 71 and the brake depression amount sensor 73. The operation detection sensors output detection results such as the accelerator opening and the brake depression amount to the vehicle control device 100. Instead of this configuration, the detection results obtained by the operation detection sensors may be output directly to the driving force output system 90 or the braking system 94 depending on the driving mode.

The switch 80 is a switch operated by an occupant of the vehicle M. The switch 80 accepts an operation performed by the occupant of the vehicle M, generates a driving mode specifying signal that specifies the driving mode of the vehicle M, and outputs the driving mode specifying signal to a switching control unit 140. The driving mode will be described later.

For example, the driving force output system 90 includes an engine and an engine ECU (Electronic Control Unit) that controls the engine if the vehicle M is a vehicle that uses an internal combustion engine as its power source. The driving force output system 90 includes a drive motor and a motor ECU that controls the drive motor if the vehicle M is an electric vehicle that uses a motor as its power source. The driving force output system 90 includes an engine, an engine ECU, a drive motor, and a motor ECU if the vehicle M is a hybrid vehicle. If the driving force output system 90 includes an engine alone, the engine ECU adjusts the throttle opening of the engine and the gear in accordance with information input thereto from a second control unit 130 (described later) and outputs a driving force (torque) that causes the vehicle M to travel. In addition, if the driving force output system 90 includes a drive motor alone, the motor ECU adjusts the duty ratio of a PWM (Pulse Width Modulation) signal supplied to the drive motor in accordance with information input thereto from the second control unit 130 and outputs the driving force described above. In addition, if the driving force output system 90 includes an engine and a drive motor, the engine ECU and the motor ECU cooperate with each other in accordance with information input thereto from the second control unit 130 to control the driving force.

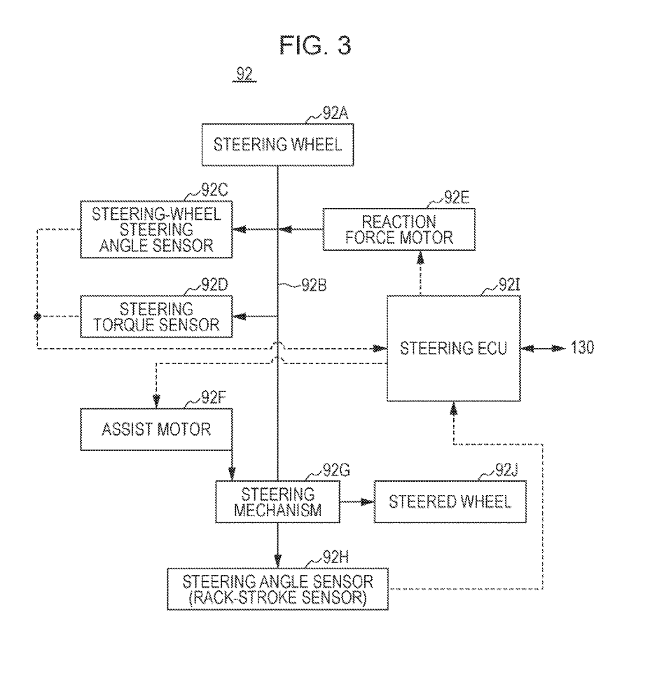

FIG. 3 is a diagram illustrating an example of the configuration of the steering unit 92. The steering unit 92 may include, but not limited to, a steering wheel 92A, a steering shaft 92B, a steering-wheel steering angle sensor 92C, a steering torque sensor 92D, a reaction force motor 92E, an assist motor 92F, a steering mechanism 92G, a steering angle sensor 92H, and a steering ECU 921.

The steering wheel 92A is an example of an operation device that accepts a steering instruction from an occupant of the vehicle M. The vehicle M may be equipped with an operation device of another type, such as a joystick, in place of the steering wheel 92A. An operation performed on the steering wheel 92A is transmitted to the steering shaft 92B. The steering-wheel steering angle sensor 92C and the steering torque sensor 92D are attached to the steering shaft 92B. The steering-wheel steering angle sensor 92C detects an angle by which the steering wheel 92A is operated and outputs the detected angle to the steering ECU 921. The steering torque sensor 92D detects a torque (steering torque) applied to the steering shaft 92B and outputs the detected torque to the steering ECU 921. The reaction force motor 92E outputs a torque to the steering shaft 92B under the control of the steering ECU 921, thereby outputting an operation reaction force to the steering wheel 92A.

The assist motor 92F outputs a torque to the steering mechanism 92G under the control of the steering ECU 921, thereby causing the steering mechanism 92G to produce a steering force. The steering mechanism 92G is, for example, a rack-and-pinion mechanism. The steering angle sensor 92H detects an amount (e.g., rack stroke) indicating the angle (steering angle) of the steering mechanism 92G and outputs the detected amount to the steering ECU 921. The steering shaft 92B and the steering mechanism 92G may be coupled in a fixed manner, may be separated, or may be coupled via a clutch mechanism.

The steering ECU 921 performs the aforementioned various kinds of controls in cooperation with the second control unit 130 of the vehicle control device 100. The steering ECU 921 may be a computer device separated from the vehicle control device 100 or may be a single computer device including the vehicle control device 100.

The braking system 94 is, for example, an electric servo braking system including brake calipers, a cylinder that transmits hydraulic pressure to the brake calipers, an electric motor that produces hydraulic pressure in the cylinder, and a braking control unit. The braking control unit of the electric servo braking system controls the electric motor in accordance with information input thereto from the second control unit 130 so that a braking torque corresponding to a braking operation is output to each wheel. The electric servo braking system may include a backup mechanism that transmits hydraulic pressure produced in response to an operation of the brake pedal to the cylinder via a master cylinder. Note that the braking system 94 is not limited to the electric servo braking system described above and may be an electrically controlled hydraulic braking system. The electrically controlled hydraulic braking system controls an actuator in accordance with information input thereto from the second control unit 130 and transmits hydraulic pressure at the master cylinder to the cylinder. In addition, the braking system 94 may include a regenerative brake that involves the drive motor that can be included in the driving force output system 90.

### Vehicle Control Device

The vehicle control device 100 will be described below. The vehicle control device 100 includes, for example, a first control unit 110, the second control unit 130, the switching control unit 140, and the storage unit 150. The first control unit 110 includes, for example, a vehicle position recognizing unit 112, an outside recognizing unit 114, an action plan generating unit 116, and a path generating unit 118. The second control unit 130 includes an acceleration/deceleration control unit 132 and a steering guiding unit 134. Some or all of the units of the first control unit 110, the second control unit 130, and the switching control unit 140 are implemented as a result of a processor, such as a CPU (Central Processing Unit), executing a program. In addition, the some or all of the units of the first control unit 110, the second control unit 130, and the switching control unit 140 may be implemented by hardware, such as an LSI (Large Scale Integration) or ASIC (Application Specific Integrated Circuit) chip. In addition, the storage unit 150 is implemented by a ROM (Read Only Memory), a RAM (Random Access Memory), a HDD (Hard Disk Drive), a flash memory, or the like. A program that is executed by the processor may be stored in the storage unit 150 in advance or may be downloaded from an external device via on-vehicle Internet-connection equipment or the like. In addition, the program may be installed in the storage unit 150 as a result of a portable storage medium storing the program thereon being put into a drive (not illustrated). The vehicle control device 100 may be implemented by a plurality of computer devices in a distributed manner.

The first control unit 110 performs control by switching the driving mode between, for example, a steering-guiding driving mode and a manual driving mode in accordance with an instruction from the switching control unit 140. The steering-guiding driving mode is a driving mode in which acceleration/deceleration of the vehicle M is automatically controlled and steering is controlled by using an operation reaction force. The manual driving mode is a driving mode in which acceleration/deceleration of the vehicle M is controlled on the basis of operations of the operation devices such as the accelerator pedal 70 and the brake pedal 72 and steering control is handed over to the occupant of the vehicle M without outputting an operation reaction force for a steering operation. When the manual operation mode is carried out, the first control unit 110 and the second control unit 130 may stop operating, and input signals from the operation detection sensors may be supplied directly to the driving force output system 90, the steering unit 92, or the braking system 94.

The vehicle position recognizing unit 112 of the first control unit 110 recognizes the lane where the vehicle M is traveling (current lane) and the relative position of the vehicle M in the current lane on the basis of map information 152 stored in the storage unit 150 and information input thereto from the rangefinders 20, the radars 30, the camera 40, the navigation system 50, and the vehicle sensors 60. The map information 152 is, for example, map information having a higher precision than the map for navigation included in the navigation system 50 and includes information concerning the center of each of lanes, the boundary of the lanes, and so forth. More specifically, the map information 152 includes information such as road information, traffic regulation information, address information (addresses/zip codes), facility information, and phone number information. The road information includes information representing the type of the road, such as a highway, a toll road, a national route, or a prefectural road and information such as the number of lanes of the road, the width of each of the lanes, the slope of the road, the location of the road (three-dimensional coordinates including the latitude, the longitude, and the altitude), the curvature of each curve of each lane, the locations of merging and branching points of each lane, and the signs provided at the road. The traffic regulation information includes information concerning each lane that is closed due to a road construction, a traffic accident, or a traffic jam.

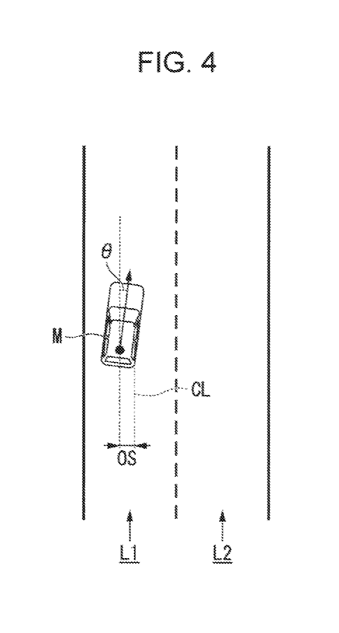

FIG. 4 is a diagram illustrating how the vehicle position recognizing unit 112 recognizes the relative position of the vehicle M in a current lane L1. The vehicle position recognizing unit 112 recognizes, for example, a difference OS of a reference point (for example, the center of gravity or the center of the rear axle) of the vehicle M from the center CL of the current lane L1 and an angle θ between the direction in which the vehicle M is traveling and the line extending at the center CL of the current lane L1 as the relative position of the vehicle M in the current lane L1. Instead of these parameters, the vehicle position recognizing unit 112 may recognize the position of the reference point of the vehicle M relative to one of the side ends of the current lane L1 as the relative position of the vehicle M in the current lane L1.

The outside recognizing unit 114 recognizes states such as the position, speed, and acceleration of each nearby vehicle on the basis of information input thereto from the rangefinders 20, the radars 30, and the camera 40. In the embodiment, a nearby vehicle is a vehicle that travels near the vehicle M in the same direction as the direction in which the vehicle M travels. The position of the nearby vehicle may be represented by a representative point, such as the center of gravity or corner of the vehicle or may be represented by an area expressed by the outline of the vehicle. The “states” of a nearby vehicle may include acceleration of the nearby vehicle and whether the nearby vehicle is performing (or is about to perform) lane changing depending on the information from the aforementioned various devices. The outside recognizing unit 114 may recognize the positions of other objects, such as guard rails, utility poles, parked vehicles, and pedestrians in addition to the positions of the nearby vehicles.

The action plan generating unit 116 sets the start point of the steering-guiding driving mode and/or the destination of the steering-guiding driving mode. The start point of the steering-guiding driving mode may be the current location of the vehicle M or the point at which the occupant of the vehicle M has performed an operation for instructing the steering-guiding driving mode. The action plan generating unit 116 generates an action plan for a section from the start point to the destination of the steering-guiding driving mode. Note that the section is not limited to this section, and the action plan generating unit 116 may generate an action plan for any given interval.

An action plan is composed of a plurality of sequentially performed events, for example. Examples of events include an deceleration event for decelerating the vehicle M, an acceleration event for accelerating the vehicle M, a lane keeping event for causing the vehicle M to travel without departing from the current lane, a lane changing event for changing the lane, an overtaking event for causing the vehicle M to overtake its preceding vehicle, a branching event for causing the vehicle M to change the lane to a desired lane at the branching point or to travel without departing from the current lane at the branching point, and a merging event for accelerating or decelerating the vehicle M on the merging lane for merging with the main lane and then causing the vehicle M to change the lane. For example, if there is a junction (branching point) in a toll road (for example, highway), the vehicle control device 100 causes the vehicle M to change or keep the lane so that the vehicle M travels in the direction of the destination when the first or second automated drive mode is performed. Accordingly, if the action plan generating unit 116 determines that there is a junction along a path with reference to the map information 152, it sets a lane changing event for changing the lane to a desired lane with which the vehicle M can travel to the direction of the destination within a section from the current location (coordinates) of the vehicle M to the location (coordinates) of the junction. Note that information representing the action plan generated by the action plan generating unit 116 is stored as action plan information 156 in the storage unit 150.

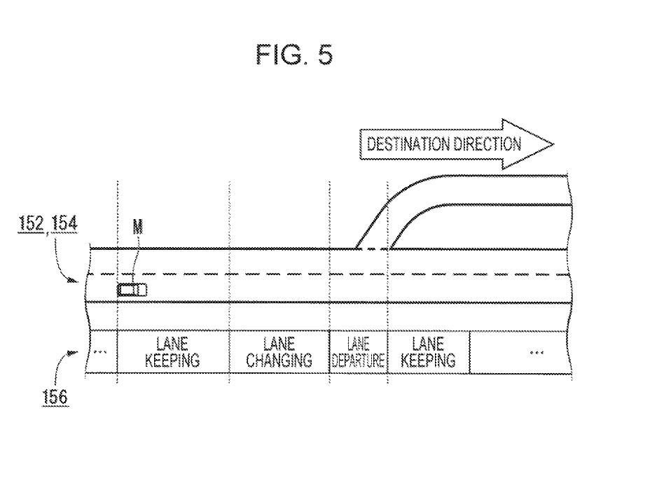

FIG. 5 is a diagram illustrating an example of an action plan generated for a certain section. As illustrated in FIG. 5, the action plan generating unit 116 classifies situations that may be encountered if the vehicle M travels along a path to the destination and generates an action plan so that events corresponding to the respective situations are carried out. Note that the action plan generating unit 116 may dynamically change the action plan in accordance with a change in the situation where the vehicle M is in.

The action plan generating unit 116 may change (update) the generated action plan on the basis of the outside state recognized by the outside recognizing unit 114, for example. In general, the outside state changes all the time while the vehicle is traveling. In particular, in the case where the vehicle M travels on the road having a plurality of lanes, distances to other vehicles change relatively. For example, when a preceding vehicle decelerates in response to sudden braking or a vehicle traveling on the next lane cuts in front of the vehicle M, the vehicle M needs to travel while appropriately changing the speed or lane in accordance with the behavior of the preceding vehicle and the vehicle on the next lane. Accordingly, the action plan generating unit 116 may change the event set for each control section in accordance with the change in the outside state described above.

Specifically, the action plan generating unit 116 changes the event set for a driving section where the vehicle M is expected to travel, if the speed of another vehicle recognized by the outside recognizing unit 114 exceeds a threshold or another vehicle traveling on the next lane moves toward the lane of the vehicle M while the vehicle M is traveling. For example, suppose that events are set such that a lane changing event follows a lane keeping event. In such a case, if the recognition result obtained by the outside recognizing unit 114 during the lane keeping event indicates that a vehicle located behind is traveling at a speed of a threshold or higher on a lane to which a lane change is to be made, the action plan generating unit 116 changes the event that follows the lane keeping event from the lane changing event to a deceleration event or a lane keeping event, for example. As a result, the vehicle control device 100 successfully implements safe automated drive of the vehicle M even if the outside state changes.

### Lane Keeping Event

When performing a lane keeping event, the action plan generating unit 116 selects a traveling mode from among a constant-speed mode, a follow mode, a deceleration mode, a curve mode, and an obstacle avoiding mode. For example, the action plan generating unit 116 selects the constant-speed mode as the traveling mode when there is no vehicle ahead of the vehicle M. The action plan generating unit 116 selects the follow mode as the traveling mode when the vehicle M follows the preceding vehicle. The action plan generating unit 116 selects the deceleration mode as the traveling mode when deceleration of the preceding vehicle is recognized by the outside recognizing unit 114 or the vehicle M performs a stopping or parking event. The action plan generating unit 116 selects the curve mode as the traveling mode when the outside recognizing unit 114 recognizes that the vehicle M is approaching a curve. The action plan generating unit 116 selects the obstacle avoiding mode as the traveling mode when an obstacle is recognized in front of the vehicle M by the outside recognizing unit 114.

The path generating unit 118 generates a path on the basis of the traveling mode selected by the action plan generating unit 116. A path is a collection (trajectory) of sampled points obtained by sampling, at predetermined intervals, target locations expected to be reached when the vehicle M travels in the traveling mode selected by the action plan generating unit 116. The path generating unit 118 calculates at least the target speed of the vehicle M on the basis of the speed of a target object OB located ahead of the vehicle M and the distance from the vehicle M to the target object OB, which are recognized by the vehicle position recognizing unit 112 and the outside recognizing unit 114. The path generating unit 118 generates a path on the basis of the calculated target speed. Examples of the target object OB include a preceding vehicle; points such as a merging point, a branching point, and a destination point; and objects such as an obstacle.

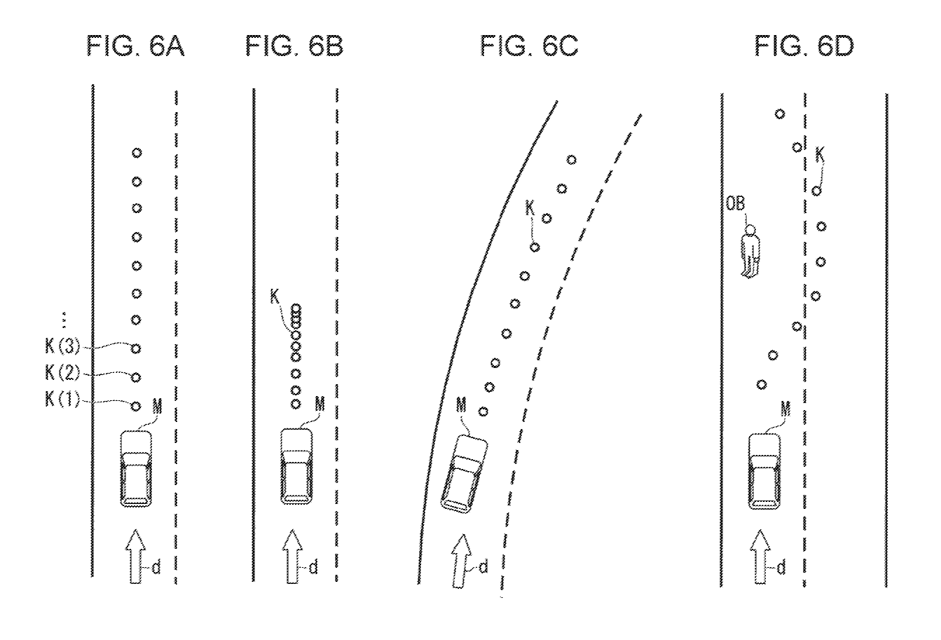

FIGS. 6A to 6D are diagrams each illustrating an example of a path generated by the path generating unit 118. As illustrated in FIG. 6A, the path generating unit 118 sets expected target locations K(1), K(2), K(3), . . . corresponding to time points at intervals of a predetermined period Δt from the current time as a path of the vehicle M by using the current location of the vehicle M as a reference. Hereinafter, these expected target locations are simply referred to as “expected target locations K” when they are not distinguished from one another. For example, the number of expected target locations K is determined in accordance with a target period T. For example, when the target period T is 5 seconds, the path generating unit 118 sets the expected target locations K along a line extending at the center of the current lane at intervals of the predetermined period Δt (0.1 second, for example) in the target period of 5 seconds and determines the intervals between the plurality of expected target locations K on the basis of the traveling mode. The path generating unit 118 may derive the line extending at the center of the current lane from information concerning the lane width included in the map information 152 or may obtain such information from the map information 152 if the map information 152 includes information concerning the location of the center of the current lane in advance.

For example, when the constant speed mode is selected as the traveling mode by the action plan generating unit 116, the path generating unit 118 generates a path by setting a plurality of expected target locations K at equal intervals as illustrated in FIG. 6A.

In addition, when the deceleration mode is selected as the traveling mode by the action plan generating unit 116 (including the case where the preceding vehicle decelerates when the follow mode is carried out), the path generating unit 118 generates a path by setting the interval between the expected target locations K that are to be reached earlier to be larger and by setting the interval between the expected target locations K that are to be reached later to be smaller as illustrated in FIG. 6B. In such a case, the preceding vehicle; a point such as a merging point, a branching point, or a target point; or an obstacle may be set as the target object OB. Since a distance between the current location of the vehicle M at the corresponding time point and an expected target location K that is to be reached by the vehicle M later gradually decreases, the second control unit 130 (described later) decelerates the vehicle M.

In addition, when the curve mode is selected as the traveling mode, the path generating unit 118 generates a path by arranging the plurality of expected target locations K while shifting their positions in a direction perpendicular to the traveling direction of the vehicle M (positions in the lane width direction), for example, in accordance with the curvature of the road as illustrated in FIG. 6C. In addition, when an obstacle OB, such as a person or a stationary vehicle, is present ahead of the vehicle M on the road as illustrated in FIG. 6D, the action plan generating unit 116 selects the obstacle avoiding mode as the traveling mode. In this case, the path generating unit 118 generates a path by arranging the plurality of expected target locations K such that the vehicle M travels while avoiding this obstacle OB.

### Lane Changing Event

When a lane changing event is performed, the path generating unit 118 performs processing, such as setting the target position range, determining whether lane changing is possible, generating a path for lane changing, and evaluating the path. The path generating unit 118 may perform the similar processing when a branching event or a merging event is performed.

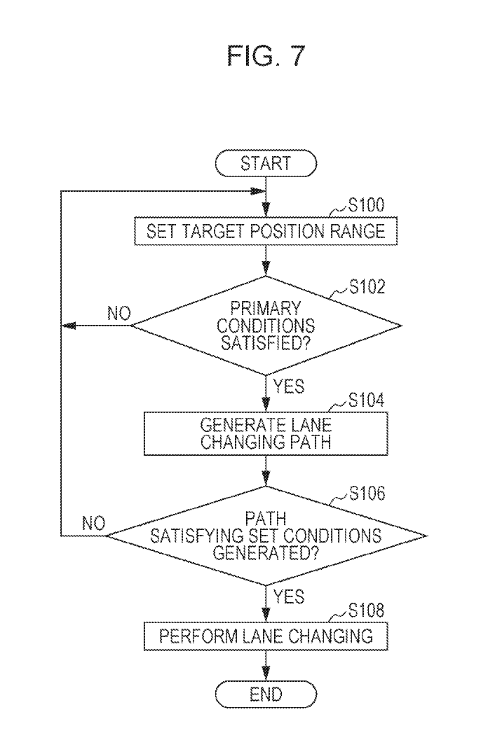

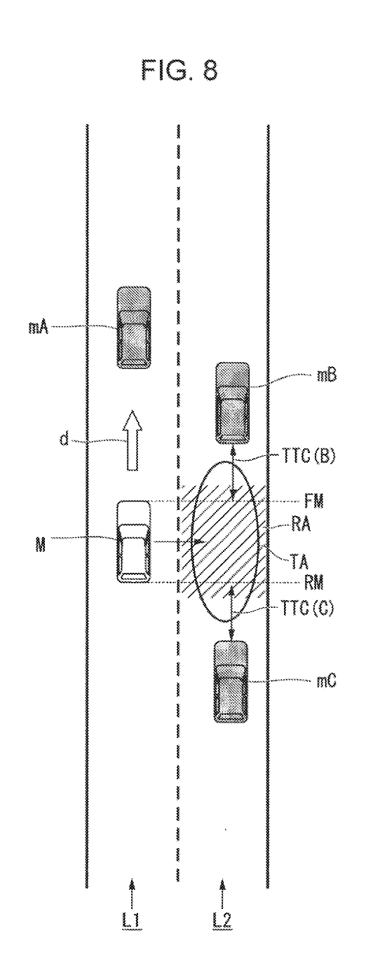

FIG. 7 is a flowchart illustrating an example of the flow of a process performed when a lane changing event is performed. The process will be described with reference to FIGS. 7 and 8.

The path generating unit 118 first identifies a vehicle that is traveling ahead of the vehicle M on an adjacent lane, which is adjacent to the current lane where the vehicle M is traveling and to which the vehicle M is to move, and identifies a vehicle that is traveling behind the vehicle M on the adjacent lane. The path generating unit 118 then sets a target position range TA between these vehicles (step S100). A description will be given below by referring to a vehicle that is traveling ahead of the vehicle M on the adjacent lane as a front reference vehicle and by referring to a vehicle that is traveling behind the vehicle M on the adjacent lane as a rear reference vehicle. The target position range TA is a relative position range based on the positional relationship among the vehicle M, the front reference vehicle, and the rear reference vehicle.

FIG. 8 is a diagram illustrating how the target position range TA is set. FIG. 8 depicts a preceding vehicle mA, a front reference vehicle mB, and a rear reference vehicle mC. FIG. 8 also depicts an arrow d that represents a traveling (moving) direction of the vehicle M, the current lane L1, and an adjacent lane L2. In the case of the example illustrated in FIG. 8, the path generating unit 118 sets the target position range TA between the front reference vehicle mB and the rear reference vehicle mC on the adjacent lane L2.

Then, the path generating unit 118 determines whether primary conditions are satisfied. The primary conditions are conditions for determining whether it is possible to perform lane changing to the target position range TA (i.e., between the front reference vehicle mB and the rear reference vehicle mC) (step S102).

For example, the primary conditions are conditions in which there is a space where no nearby vehicle is present in a restrained area RA set in the adjacent lane and time to collision TTC for the vehicle M and the front reference vehicle mB and time-to-collision TTC for the vehicle M and the rear reference vehicle mC are larger than respective thresholds. If the primary conditions are not satisfied, the process returns to step S100 in which the path generating unit 118 sets the target position range TA again. At that time, a timing at which the target position range TA that satisfies the primary conditions becomes settable may be waited for, or the target position range TA may be to be in front of the front reference vehicle mB or behind the rear reference vehicle mC and speed control may be performed so that the vehicle M is located side by side with the target position range TA.

As illustrated in FIG. 8, the path generating unit 118 projects the vehicle M to the adjacent lane L2 to which the vehicle M is to move and sets the restrained area RA having a small marginal distance in front and behind. The restrained area RA is set to extend from one transversal end to the other transversal end of the adjacent lane L2.

If there is no nearby vehicle in the restrained area RA, the path generating unit 118 assumes an extending line FM and an extending line RM that are obtained by virtually extending the front end and the rear end of the vehicle M to the adjacent lane L2 to which the vehicle M is to move, for example. The path generating unit 118 calculates time-to-collision TTC(B) for the extending line FM and the front reference vehicle mB and time-to-collision TTC(C) for the extending line RM and the rear reference vehicle mC. The time-to-collision TTC(B) is derived by dividing the distance between the extending line FM and the front reference vehicle mB by the relative speed between the vehicle M and the front reference vehicle mB. The time-to-collision TTC(C) is derived by dividing the distance between the extending line RM and the rear reference vehicle mC by the relative speed between the vehicle M and the rear reference vehicle mC. The path generating unit 118 determines that the primary conditions are satisfied if the time-to-collision TTC(B) is larger than a threshold Th(B) and the time-to-collision TTC(C) is larger than a threshold Th(C). The thresholds Th(B) and Th(C) may be the same value or different values.

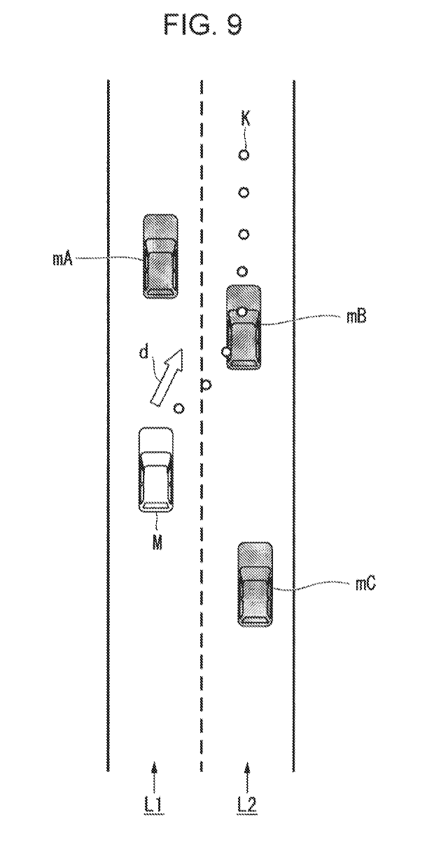

If the primary conditions are satisfied, the path generating unit 118 generates a path for lane changing (step S104). FIG. 9 is a diagram illustrating how a path for lane changing is generated. For example, the path generating unit 118 assumes that the preceding vehicle mA, the front reference vehicle mB, and the rear reference vehicle mC travel in accordance with a predetermined speed model, and generates a path on the basis of the predetermined speed model of these three vehicles and the speed of the vehicle M such that the vehicle M is to be located between the front reference vehicle mB and the rear reference vehicle mC at a certain future time point without interfering with the preceding vehicle mA. For example, the path generating unit 118 smoothly links the current location of the vehicle M and the location of the front reference vehicle mB at the certain future time point or the lane changing end point at the center of the lane to which the vehicle M is to move by using a polynomial curve, such as a spline curve, and arranges the predetermined number of expected target locations K along this curve at equal or unequal intervals. At that time, the path generating unit 118 generates a path such that at least one of the expected target locations K is located within the target position range TA.

Then, the path generating unit 118 determines whether a path that satisfies set conditions has been successfully generated (step S106). The set conditions may be, for example, the acceleration/deceleration, the steered angle, and the expected yaw rate at each point along the path being within respective predetermined ranges. If a path that satisfies the set conditions has been successfully generated, the path generating unit 118 outputs information of the path for lane changing to the second control unit 130 to cause a lane changing to be performed (step S108). If generation of a path that satisfies the set conditions has failed, the process returns to step S100. In this case, the path generating unit 118 may enter the standby state or may perform processing such as setting the target position range TA again as in the case of NO in step S102.

### Operation Reaction Force

The individual units of the second control unit 130 perform the following processing while the steering-guiding driving mode is carried out.

The acceleration/deceleration control unit 132 of the second control unit 130 identifies a speed for realizing a speed component (represented by a spacing between points on the path) included in the path generated by the path generating unit 118 and outputs an instruction for achieving the speed to the driving force output system 90 or the braking system 94.

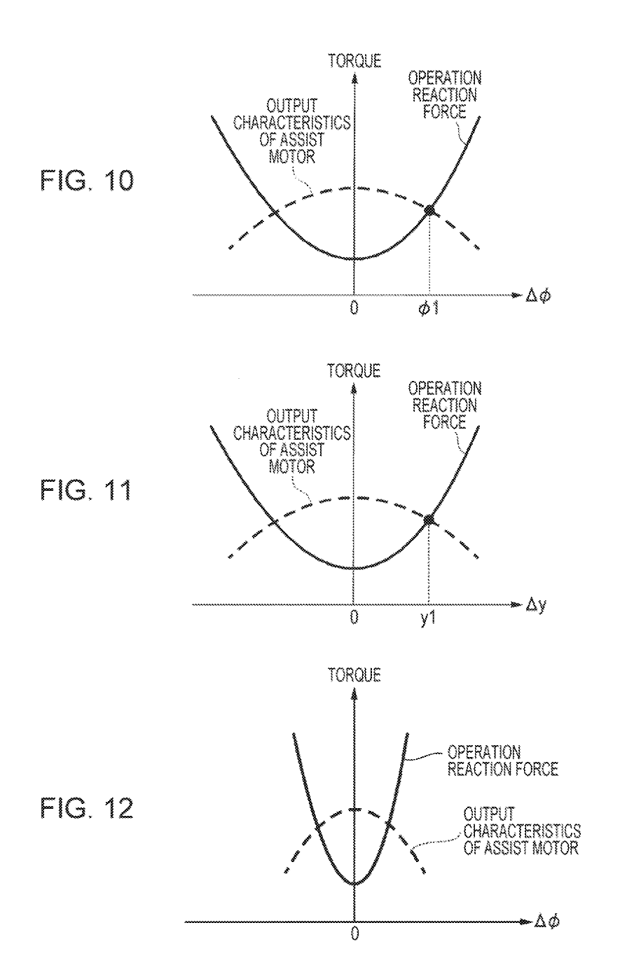

The steering guiding unit 134 of the second control unit 130 perform control by applying an operation reaction force output by the reaction force motor 92E of the steering unit 92 in a direction for suppressing deviation from the path. FIG. 10 is a diagram for describing an example of an operation reaction force determination method. The horizontal axis of FIG. 10 represents a difference Δφ between the target steering angle and the steering angle (measured value) recognized based on the detection result obtained by the steering-wheel steering angle sensor 92C or the steering angle sensor 92H, and the vertical axis represents the operation reaction force. The target steering angle is calculated based on a difference between the direction in which the vehicle M is currently oriented and the direction toward the next target location K from the location of the vehicle M by taking into account the body design (such as wheelbase) of the vehicle M, the yaw rate, and so forth. The difference Δφ is positive when the deviation is in the right direction and is negative when the deviation is in the left direction. The operation reaction force is represented by torque, for example. As illustrated in FIG. 10, the steering guiding unit 134 increases the operation reaction force as the absolute value of the difference Δφ increases. For example, if the difference Δφ is equal to φ1, that is, if the steering angle (measured value) deviates in the right direction by φ1, as illustrated in FIG. 10, the operation reaction force to be applied when the steering wheel 92A is operated to the right is larger than the operation reaction force to be applied when the steering wheel 92A is operated to the left, and as a result, the occupant of the vehicle M feels it “heavier” to operate the steering wheel 92A to the right. The slope of this operation reaction force may be set such that the operation reaction force becomes stronger as the absolute value of the difference Δφ increases as indicated by the fact that the characteristic curve illustrated in FIG. 10 is convex downward.

In addition to outputting an operation reaction force, the second control unit 130 may change the output characteristics of the assist torque produced by the assist motor 92F in accordance with the output characteristic of the operation reaction force. In this case, the second control unit 130 sets the assist torque for an operation to the side opposite to the side where the operation reaction force increases to be larger than the assist torque for an operation to the side where the operation reaction force increases. A dash-line curve illustrated in FIG. 10 represents the output characteristics of the assist motor 92F of this case. For example, if the difference Δφ is equal to φ1, that is, if the steering angle (measured value) deviates to the right by φ1, the second control unit 130 may output an instruction signal to the steering ECU 921 to set the assist torque for the case where the steering wheel 92A is operated to the left to be larger than the assist torque for the case where the steering wheel 92A is operated to the right. In this way, the steering angle of the vehicle M is successfully made close to the target steering angle more strongly. The same applies to the following cases.

The operation reaction force may be determined on the basis of a difference Δy between the target location K and the lateral position of the vehicle M instead of the difference Δφ between the target steering angle and the steering angle (measured value). FIG. 11 is a diagram for describing another example of an operation reaction force determination method. The horizontal axis of FIG. 11 represents the difference Δy between the target location K and the lateral position of the vehicle M. The lateral position is a relative position of the reference point (e.g., the center of gravity or the center of the rear axle) of the vehicle M in the lane where the vehicle M is traveling. The difference Δy is positive when the deviation is in the right direction and is negative when the deviation is in the left direction. The operation reaction force is represented by torque, for example. As illustrated in FIG. 11, the steering guiding unit 134 increases the operation reaction force as the absolute value of the difference Δy increases. For example, if the difference Δy is equal to y1, that is, if the lateral position deviates from the target location K by y1 to the right, as illustrated in FIG. 11, the operation reaction force for the case where the steering wheel 92A is operated to the right is set to be larger than the operation reaction force for the case where the steering wheel 92A is operated to the left. As a result, the occupant of the vehicle M feels it “heavier” to operate the steering wheel 92A to the right. The following description will be given on the assumption that the operation reaction force is determined on the basis of the difference between the target steering angle and the steering angle (measured value) as illustrated in FIG. 10.

The steering guiding unit 134 increases the degree by which deviation from the path is suppressed, for example, by relatively increasing the operation reaction force with respect to the difference Δφ in particular situations. The particular situations are situations where it is necessary to control the lateral position of the vehicle M precisely, and an example of such situations includes a situation where the vehicle M performs lane changing (lane changing event is carried out). FIG. 12 is a diagram illustrating how the operation reaction force with respect to the difference Δφ is relatively increased. In this case, the output characteristics of the assist motor 92F may be similarly represented by a sharper curve.

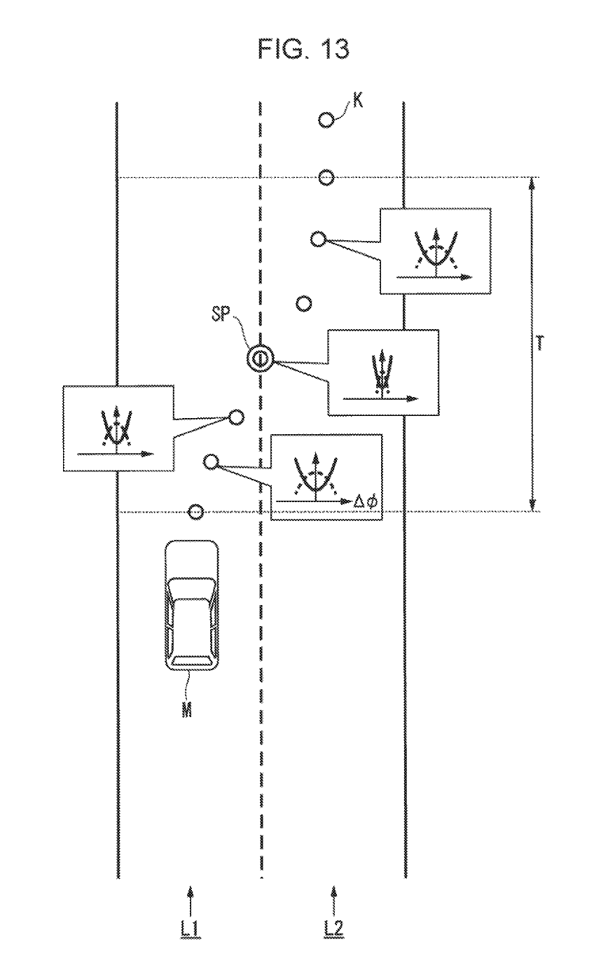

When the vehicle M performs lane changing, the steering guiding unit 134 may gradually increase the degree of suppressing the deviation from the path and may set the degree of suppressing the deviation from the path to be the largest at a timing at which the reference point (such as the center of gravity or the center of the rear axle) of the vehicle M crosses the lane marking. FIG. 13 is a diagram illustrating how the degree of suppressing the deviation from the path is changed before and after lane changing. In FIG. 13, the degree of suppressing the deviation from the path becomes the largest at a point SP at which the reference point of the vehicle M crosses the lane marking. In FIG. 13, a period T indicates a period for which lane changing is performed.

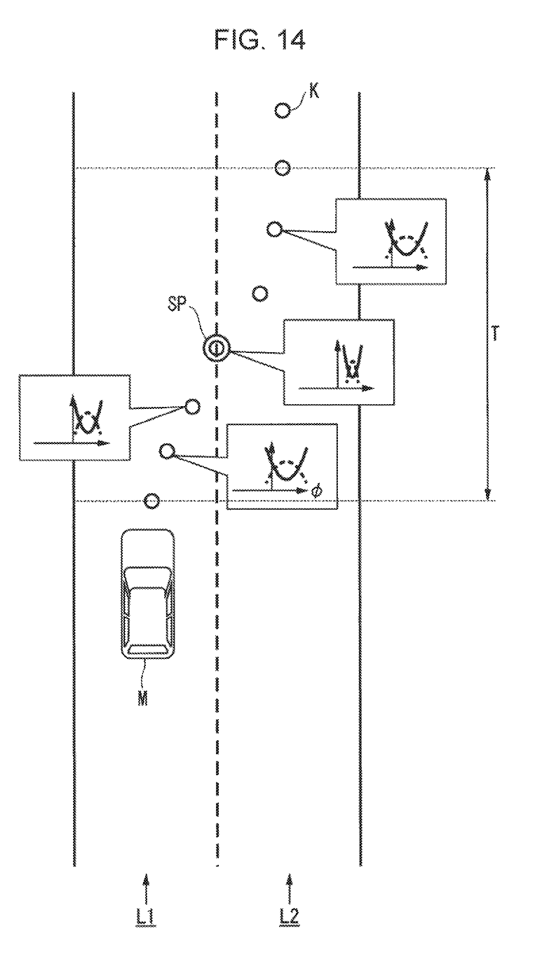

The above description has been given on the assumption that the operation reaction force is determined on the basis of the difference Δφ between the target steering angle and the steering angle (measured value); however, the operation reaction force may be determined on the basis of the steering angle (measured value) by moving the central axis of the characteristic curve of the operation reaction force in accordance with the target steering angle. FIG. 14 is a diagram illustrating how the operation reaction force is determined on the basis of the steering angle (measured value). Such a principle is similarly applied to the case where control is performed on the basis of the lateral position of the vehicle M.

The particular situations are not limited to the situation of lane changing. Various situations where it is necessary to control the lateral position of the vehicle M precisely, for example, a situation where a large vehicle is traveling in the vicinity of the vehicle M and a situation where a lane is closed due to a road construction or a traffic accident, may be handled as the particular situations.

### Switching Control

The switching control unit 140 switches the driving mode on the basis of the driving mode specifying signal input from the switch 80. The switching control unit 140 also switches the driving mode on the basis of an operation of the operation device for acceleration, deceleration, or steering. The switching control unit 140 switches the driving mode from the steering-guiding driving mode to the manual driving mode around the destination of the steering-guiding driving mode.

In the case of switching the driving mode on the basis of an operation of the operation device for acceleration, deceleration, or steering, the switching control unit 140 switches the driving mode from the steering-guiding driving mode to the manual driving mode if a state where the operation amount (such as an amount of change in the accelerator opening, the brake depression amount, the steering torque, or the steering-wheel steering angle) is greater than or equal to a threshold is continued for a reference period or longer.

If a threshold relating to steering torque is set in the case where the driving mode is switched on the basis of an operation of the steering wheel 92A to input a steering instruction, the threshold is set to a value larger than the reaction force output by the reaction force motor 92E. In this case, the switching control unit 140 may switch the driving mode from a reaction-force-guiding driving mode to a driving mode in which only acceleration/deceleration is automatically controlled in stead of switching from the steering-guiding driving mode to the manual driving mode.

According to the vehicle control device 100 according to the first embodiment described above includes the path generating unit that generates a target path to be taken by the vehicle M to reach the destination and the second control unit 130 that controls at least steering of the vehicle M such that the vehicle M travels along the path generated by the path generating unit 118 and that increases the degree of suppressing deviation from the path in particular situations. With such a configuration, the vehicle control device 100 successfully makes the occupant of the vehicle feel safe in particular situations.

### Second Embodiment

A second embodiment will be described below. The vehicle M performs a steering-guiding driving mode in the first embodiment, whereas the vehicle M is capable of traveling in automated drive mode in the second embodiment. The automated drive mode is a driving mode in which acceleration/deceleration and steering of the vehicle M is automatically controlled.

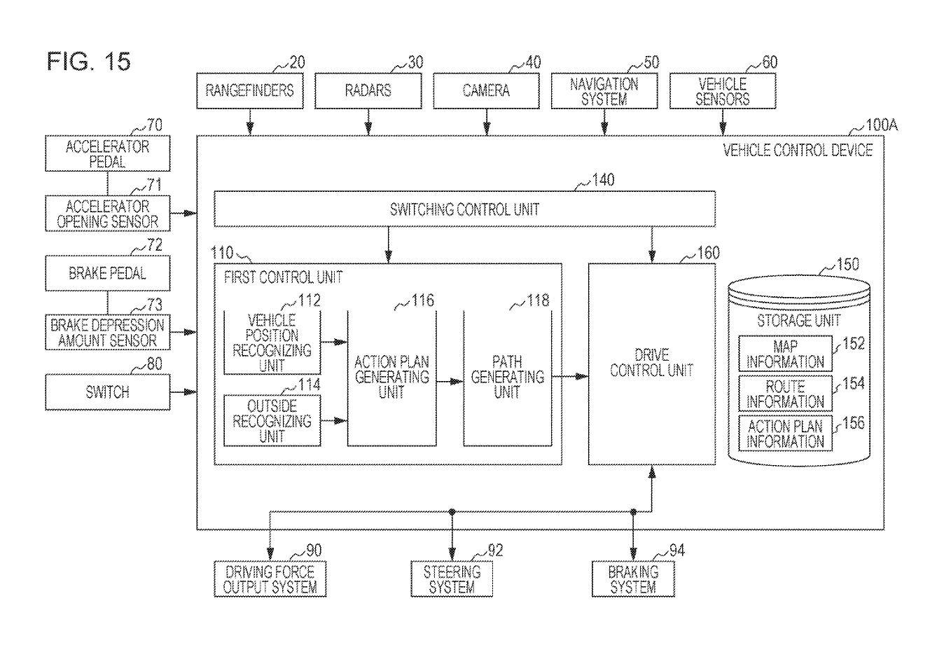

FIG. 15 is a diagram illustrating an example of the configuration of a vehicle control device 100A according to the second embodiment. The vehicle control device 100A includes a drive control unit 160 instead of the second control unit 130 when it is compared with the vehicle control device 100 according to the first embodiment. The drive control unit 160 controls the driving force output system 90, the steering unit 92, and the braking system 94 such that the vehicle M travels along a path generated by the path generating unit 118 at expected timing.

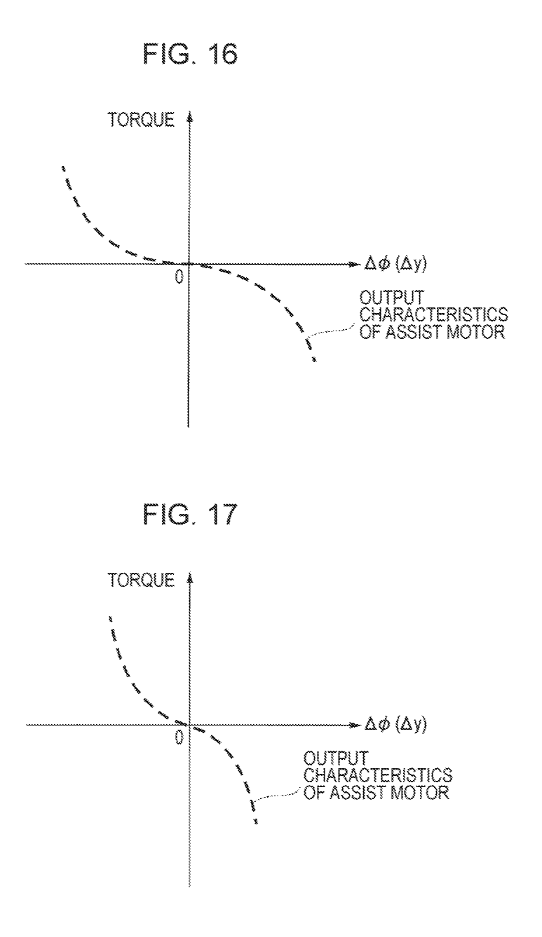

At that time, if the steering angle (measured value) of the vehicle M deviates from the target steering angle due to a control error, a disturbance, or the like, the drive control unit 160 controls the assist motor 92F to output a torque for decreasing the deviation (which is not an assist torque but is a spontaneously output torque in this case). FIG. 16 is a diagram illustrating output characteristics of the assist motor 92F according to the second embodiment. As illustrated in FIG. 16, the drive control unit 160 causes the assist motor 92F to output a torque in the left direction (negative direction) if the steering angle (measured value) of the vehicle M deviates from the target steering angle in the right direction (positive direction). In addition, the drive control unit 160 causes the assist motor 92F to output a torque in the right direction (positive direction) if the steering angle (measured value) of the vehicle M deviates from the target steering angle in the left direction (negative direction). Such a principle is similarly applied to the case where control is performed based on the lateral position.

The drive control unit 160 increases the degree of suppressing deviation from the path by making the output of the assist motor 92F sharper in particular situations as in the first embodiment. FIG. 17 is a diagram illustrating how the output characteristics of the assist motor 92F are relatively increased. With this configuration, the vehicle control device 100A according to the second embodiment successfully makes the occupant of the vehicle feel further safe in particular situations as in the first embodiment.

According to the second embodiment described above, the occupant of a vehicle can feel further safe in particular situations as in the first embodiment.

While how the present disclosure is embodied has been described by using the embodiments above, the present disclosure is not limited to such embodiments, and various modifications or replacements may be made within a scope not departing from the essence of the present disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A vehicle control device comprising:
a path generating unit that generates a target path used by a vehicle to reach a destination; and
a controller that controls steering of the vehicle such that the vehicle travels along the target path by suppressing deviation of the vehicle from the target path by a predetermined suppressing degree,
wherein the controller increases the suppressing degree in a particular situation.

2. The vehicle control device according to claim 1, wherein the particular situation is a situation where the vehicle performs lane changing in accordance with the target path generated by the path generating unit.

3. The vehicle control device according to claim 2, wherein the controller increases the suppressing degree to the largest degree at a timing when a reference point of the vehicle crosses a lane marking during the lane changing.

4. The vehicle control device according to claim 1, further comprising:
a reaction force output unit that outputs an operation reaction force against an operation device that accepts a steering instruction from an occupant of the vehicle,
wherein the controller controls the operation reaction force to suppress the deviation of the vehicle from the target path.

5. The vehicle control device according to claim 1, further comprising:
a steering force output unit that outputs a steering force to turn a wheel of the vehicle,
wherein the controller controls the steering force output by the steering force output unit to suppress the deviation of the vehicle from the target path.

6. The vehicle control device according to claim 5, wherein the controller controls the steering force output by the steering force output unit such that, if an operation performed on an operation device that accepts a steering operation from an occupant of the vehicle is in a direction for suppressing the deviation from the target path, the controller sets a first steering force to be output by the steering force output unit in a direction corresponding to the operation, and if the operation performed on the operation device is in a direction for increasing the deviation from the target path, the controller sets a second steering force to be output by the steering force output unit in a direction corresponding to the operation,
wherein the first steering force is set to be larger than the second steering force.

7. A vehicle control method performed by a computer mounted in a vehicle, comprising:
generating, by using the computer, a target path used by the vehicle to reach a destination;
controlling, by the computer, steering of the vehicle such that the vehicle travels along the generated target path by suppressing deviation of the vehicle from the target path by a predetermined suppressing degree; and
increasing, by the computer, the suppressing degree in a particular situation.

8. A non-transitory computer readable medium storing a vehicle control program that causes an onboard computer to execute:
a process of generating a target path used by the vehicle to reach a destination;
a process of controlling steering of the vehicle such that the vehicle travels along the generated target path by suppressing deviation of the vehicle from the target path by a predetermined suppressing degree; and
a process of increasing the suppressing degree in a particular situation.

9. The vehicle control device according to claim 1, wherein the controller increases the suppressing degree in accordance with the particular situation of travel of the vehicle even though a degree of the deviation of the vehicle from the target path is equal to the degree of the deviation of the vehicle from the target path in another situation.
